(19) United States
(12) Patent Application Publication
(10) Pub. No.: US 2005/0194885 A1
(43) Pub. Date: Sep. 8, 2005

(54) Red emission organic phosphor with broad excitation band

(75) Inventors: Xiao Zhang, Singapore (SG); XianTing Zeng, Singapore (SG)

Correspondence Address: PALMER & DODGE, LLP;KATHLEEN M. WILLIAMS, 111 HUNTINGTON AVENUE, BOSTON, MA, 02199, US

(73) Assignee: Agency for Science, Technology and Research

(21) Appl. No.: 11/049,274

(22) Filed: Feb. 2, 2005

(30) Foreign Application Priority Data
Feb. 4, 2004 (SG) 200400569-0

(51) Int. Cl. H05B 33/00; H05B 33/04

(52) U.S. Cl. 313/486; 313/485; 313/487; 313/512

(57) ABSTRACT

A phosphor of the general formula Eu(A)₃₋ₓ(B)₂ₓ₊₂ where A is a β-diketone and B is an organic phosphine oxide (R₃PO—R═, aryl, alkylene acyl, phenyl and their derivatives. The phosphor being synthesize in a single step process where a lanthanide ion solution is added to a β-diketone and organic phosphine oxide mixture. The phosphor having a high intensity red line emission at between 610 to 620 nm depending on ligand groups.

### RELATED APPLICATIONS

This application claims priority to Singapore Application Number 200400569-0, filed on Feb. 4, 2004, the entirety of which is incorporated herein by reference.

### TECHNICAL FIELD

This invention relates to organic phosphors that produce red emission when excited by UV or blue light, and more particularly to organic phosphors in the lanthanide series including Europium, Terbium, Cerium and Erbium.

### BACKGROUND OF THE INVENTION

The phenomenon of photoluminescence or phosphorescence displayed by phosphors, which when excited by UV and visible light emit light in the visible spectrum, is used in a wide variety of applications. The application of photoluminescence phosphors covers uses in conjunction with light emitting diodes (LED), flat panel plasma display, optical sensors, fluorescent lamps and other diagnostic tools. For current LED-based white light emitting sources the low energy consumption required for photoluminescence of phosphors is taken advantage of in LED devices. While the low energy consumption is an advantage, the light emitted by existing phosphors suitable for use in this application does not cover the full range of color in the visible light spectrum. In color display devices, the reproduction of color images depends on color information represented by the primary colors of visible light—red, green and blue. Of the phosphors readily available, most emit green and at most orange light when exposed to long wavelength UV or blue light. This limitation of the phosphors in turn limits the color sensitivity of devices using the phosphors for generating white light and color emissions with LEDs. It is desired to have highly efficient phosphors that emit red light of high intensity and purity to improve the color sensitivity for existing display devices.

White light produced by a lighting source includes a diverse range of light ranging from warm light to cool light and this diversity is measured by a Color Temperature (CT) scale. The quality of the light source, the relative reproducibility of a certain color under the light source, is ascertained by a Color Rendering Index (CRI) scale. The higher the CRI, the greater the ease of reproducing a particular color under that light source. To generate full white light which has a diverse Color Temperature (CT) range and a high (CRI), the phosphor used with the LED needs to have red-line emission capability. Although improvements have been made to the limitations of existing phosphors to provide red light emitting phosphors (as in U.S. Published Application No.: 20020158565 which disclosed an inorganic phosphor capable of giving a broadband red emission), a red line emission phosphor of a suitable intensity and color, which in combination with LED would produce white light with a high CRI has yet to be achieved.

U.S. Pat. No. 6,051,925 (“the '925 patent”) discloses a diode-addressed color display comprising an UV-diode and organic phosphors, having the general formula [Eu(diketone)₃X,X′]. According to the '925 patent, the phosphors emit red light at 613 nm, 618 nm and 705 nm when excited by energy sources having wavelength of 260 m to 400 nm in the near UV range. The synthesis of this phosphor requires a 2-step process where an intermediate is produced from which the final phosphor is synthesized. Since the quality of the intermediate is crucial in determining the quality and yield of the desired phosphor this 2-step synthesis is less efficient.

While U.S. Pat. No. 6,165,631 (“the '631 patent”) also provides a diode-addressed color display which comprises a europium-containing or samarium-containing phosphor capable of emitting red light on exposure to UV radiation, the phosphors with a general formula of Ln(L)₃(X)₂ also require a 2-step synthesis process and therefore suffers from the same problems mentioned above.

Although the polycrystalline Eu(TTA)₃(TPPO)₂ powder synthesized by the process in “Time Resolved Spectroscopic Study Of Eu(TTA)₃(TPPO)₂ Chelate In-Situ Synthesis In Vinyltriethoxisilane-Derived Sol-Gel-Process-Glass”, G. Qian et al/Journal of Luminescence 96 (2002) 211-18, produces a desired red line emission when excited by a broad band light source, the process requires the addition of ammonia.

Similarly, the synthesis process disclosed in “Mono-thio-β-diketones—A new Type of Ligands Suitable for Sensitization of Lanthanide Luminescence, Infrared Luminescence Of An Intensely Colored Neodymium And Yetterbium Mono-Thio-β-Diketone Chelates”, A. I. Voloshin et al/Journal of Luminescence 93 (2001) 115-118, requires an alkali to produce a phosphor of the general formula Ln(L)₃(TPPO)₂.

### SUMMARY OF THE INVENTION

The present invention is a process of producing an organic phosphor of rare earth metals with a high intensity red emission capabilities when excited by external light source of blue, near UV or UV.

The invention provides a process of synthesizing an organic phosphor, the process comprises preparing an ionic solution of a lanthanide series element; preparing a −β-diketone solution; preparing an organic phosphine oxide solution; mixing the β-diketone and organic phosphine oxide solutions together at a mole ratio of X:Y=3−x:2+2x, −1≦x<3, to form a homogenous ligand solution; and adding the ionic solution of the lanthanide series element with continuous stirring to the homogenous ligand solution.

Preferably, the β-diketone solution and the organic phosphine oxide solution have the same concentration.

It is preferred that the mole ratio X:Y is altered to produce phosphors of different stoichiometric combination of β-diketone and organic phosphine oxide ligands.

More preferably, x is in the range defined by −0.5<x<1.

In one aspect of the invention, the ionic solution of the lanthanide series element is formed by dissolving a compound of the lanthanide series element in deionised water. The compound of the lanthanide series element being selected from a group consisting of a chloride and a nitrate. Additionally, the ionic solution of the lanthanide series element is acidic.

Another aspect of the invention has the lanthanide series element selected from the group consisting europium, terbium, cerium and erbium.

The present invention also provides an organic phosphor formed according to the process of synthesizing an organic phosphor comprising preparing an ionic solution of a lanthanide series element preparing a β-diketone solution; preparing an organic phosphine oxide solution; mixing the β-diketone and organic phosphine oxide solutions together at a mole ratio of X:Y=3−x:2+2x, −1≦x<3, to form a homogenous ligand solution; and adding the ionic solution of the lanthanide series element with continuous stirring to the homogenous ligand solution, the phosphor having a general formula:
Eu(A)₃₋ₓ(B)₂₊₂ₓ
where Ln represents a lanthanide series element; A represents a β-diketone as one of two types of ligand; and where B represents an organic phosphine oxide, R₃PO, as the second of two types of ligand, where R=alkyl, alkylene, aryl, phenyl and their derivatives. The β-diketone molecule having a two adjacent C═O carbons linked by exactly one (CH₂) carbon atom in the molecular chain. Some examples of β-diketone includes trifluorobutanediones such as thenoyl-trifluoroacetone (TTA), naphthyl-trifluoroacetone (N-TA), benzoyl-trifluoroacetone (B-TA), furoyl-trifluoroacetone (F-TA) and other kinds of β-diketones such as R-1,3-propanedione, R-2,4-butanedine, where R=alkyl, alkylene, aryl, phenyl and their derivatives.

Preferably, x is in a range defined by −0.5<x<1.

In an aspect of the present invention, the phosphor produces a red luminescence when exposed to UV light.

In one aspect of the present invention, the phosphor produces a red luminescence when exposed to blue light.

In another aspect of the present invention, the phosphor has a broad excitation spectrum ranging from 250 nm to 472 nm.

In yet another aspect, the phosphor produces a red luminescence at wavelength at 618 nm, 610 nm and 582 nm when exposed to an excitation source that fall within the excitation spectrum of 250 nm to 472 nm.

In an alternative aspect, the phosphor has an intensity that varies with the content of organic phosphine oxide in a phosphor molecule. The red luminescence emitted by the phosphor increases in intensity as the proportion of organic phosphine oxide, one of the ligands in a lanthanide chelate, increases.

The invention also provides a phosphor that dissolves in organic solvents to mix with a resin to form a light converting transparent polymer.

In an alternative aspect, the present invention provides a phosphor having a general formula:
Ln(A)₃₋ₓ(B)₂₊₂ₓ
where Ln represents a lanthanide series element; A represents a β-diketone as one of two types of ligand; and where B represents an organic phosphine oxide, R₃PO, as the second of two types of ligand, where R=alkyl, alkylene, aryl, phenyl and their derivatives, where x is defined in the range of −0.5<x<0 and 0<x<1.

In yet another aspect of the invention, a device comprising a resin, a light source and a phosphor produced by the said process of synthesizing an organic phosphor is formed when the phosphor is dissolved in an organic solvent and mixed with the resin to form a transparent polymer which converts the color of light from the light source that passes through.

One aspect has the color of the converted light source by the transparent polymer dependent on the type of light source applied in the device and the mole ratio, X:Y=3−x:2+2x, of A and B of the phosphor, where the mole ratio is determined by x. Preferably x is defined by the range −0.5<x<1.

The invention provides alight emitting device which comprises of a light source operating in the range of 240 nm to 470 nm; a phosphor produced by the said process of synthesizing an organic phosphor, having a general formula: Ln(A)₃₋ₓ(B)₂₊₂ₓ; where Ln represents a lanthanide series element; A represents a β-diketone as one of two types of ligand; and where B represents an organic phosphine oxide, R₃PO, as the second of two types of ligand, where R=alkyl, alkylene, aryl, phenyl and their derivatives; and −1<x<3, such that on excitation by the light source, the phosphor emits light of high intensity that fall within the range of 580 nm to 620 nm.

### BRIEF DESCRIPTION OF THE DRAWINGS

For a better understanding of the present invention and to show how it may be performed, embodiments hereof will now be described by way of non-limiting examples only, with reference to the accompanying drawings wherein:

FIG. 1 is a graph showing the emission intensity of a group of phosphors of an example of the present invention;

FIG. 2 is a graph showing excitation spectra of the same group of the phosphors in FIG. 1 of the present invention;

FIG. 3 is a graph showing the emission intensity of a group of phosphors of another example of the present invention;

FIG. 4 is a graph showing the excitation spectra of the same group of the phosphors in FIG. 3 of the present invention;

FIG. 5 is a graph showing a comparison of the excitation spectra of two samples selected from one of the two examples illustrated in FIG. 2 and FIG. 4.

### DETAILED DESCRIPTION OF THE INVENTION

The present invention provides a process for synthesizing a red emission organic phosphor having a general formula: Eu(A)₃₋ₓ(B)₂₊₂ₓ. The phosphor is precipitated from a mixture of A, which is a β-diketone, and B, which is an organic phosphine oxide (R₃PO) when a solution of lanthanide ion is added drop wise to the mixture. A β-diketone molecule has two adjacent C═O groups connected by a common carbon atom in the organic chain. The C═O groups allow the β-diketone molecule to act as an anionic ligand for the positively charged metal center of the Ln³⁺. The molecule of organic phosphine oxide (R₃PO) having one oxygen act as a neutral ligand in the lanthanide phosphor.

The mixture of β-diketone and organic phosphine oxide (R₃PO) is prepared by stirring both solutions in a mole ratio of X:Y, where X=3−x and Y=2+2x respectively for 15 minutes to 30 minutes, where x=−0.5 to 1. The β-diketone solution is prepared by dissolving in ethanol one of the following compounds: trifluoro-diketone, thenoyl-trifluoroacetone (TTA), naphthyl-trifluoroacetone (N-TA), benzoyl-trifluoroacetone (B-TA), furoyl-trifluoroacetone (F-TA) or other diketone such as 1-(2-hydroxyphenyl)-3-phenyl-1,3-propanedione, and 1-phenyl-1,3-butanedione such that the concentration of the solution is between 0.01 to 5.00 Mol and preferably between 0.20 to 2.00 Mol. The organic phosphine oxide (R₃PO) solution is obtained by dissolving in ethanol one of the following compounds: triphenyl-phosphine oxide (TPPO), trioctyl phosphine oxide (TOPO), tris(cyclohexyl) phosphine oxide (TCHPO), (diphenylmethyl) diphenyl-phosphone oxide (DPMDPPO) to form a solution having a concentration between 0.01 to 5.00 Mol and preferably between 0.20 to 2.00 Mol to obtain better results.

The lanthanide ion solution is prepared by having a compound or a salt of the lanthanide series metals like europium, terbium, cerium and erbium dissolved in deionised water or acid to form a solution of the lanthanide ion having a concentration between 0.01 to 5.00 Mol. Although not all lanthanide ion solutions are dissolved in acid, the dissolution of the salt of these rare earth metals, usually nitrates or chlorides, in deionised water would usually give raise to an acidic environment in view of the chloride ions and the nitrate ions in the same solution of the dissolved salts. The solution is stirred thoroughly to ensure that the compound is completely dissolved before it is added dropwise to the mixture of ligands containing P-diketone and organic phosphine oxide to precipitate the lanthanide phosphor. The mixture is stirred for about 2 hours to allow complete reaction before the precipitated lanthanide phosphor is filtered, washed by deionised water and dried at 60° C. to 80° C.

The above process is a single step process that is easy to implement and cost-effective for phosphor fabrication. It is also apparent from the following examples that the present invention does not require the addition of a base to provide a alkali environment for the synthesis of the phosphor as disclosed in the process in “Time Resolved Spectroscopic Study Of Eu(Tta)₃(Tppo)₂ Chelate In-Situ Synthesis In Vinyltriethoxisilane-Derived Sol-Gel-Process-Glass”, G. QIAN ET AL/JOURNAL OF LUMINESCENCE 96 (2002) 211-18 and “Mono-thio-β-diketones—A new Type of Ligands Suitable for Sensitization of Lanthanide Luminescence. Infrared Luminescence Of An Intensely Colored Neodymium And Yetterbium Mono-Thio-β-Diketone Chelates”, A. I. Voloshin et al/Journal of Luminescence 93 (2001) 115-118.

### EXAMPLE 1

### Preparation of Eu(TTA)₃(TPPO)2

10 mmol of europium nitrate pentahydrate is dissolved in 20 ml of deionised water to form a solution of europium ion (Eu³⁺) having concentration of about 0.5 Mol. 30 mmol of thenyltrifluoroacetone (TTA) is dissolved in 30 ml of ethanol to obtain a β-diketone solution having a concentration of 1 Mol. 20 mmol of triphenyl phosphine oxide (TPPO) is dissolved in 20 mol of ethanol to form a solution of phosphine oxide of concentration of 1 Mol.

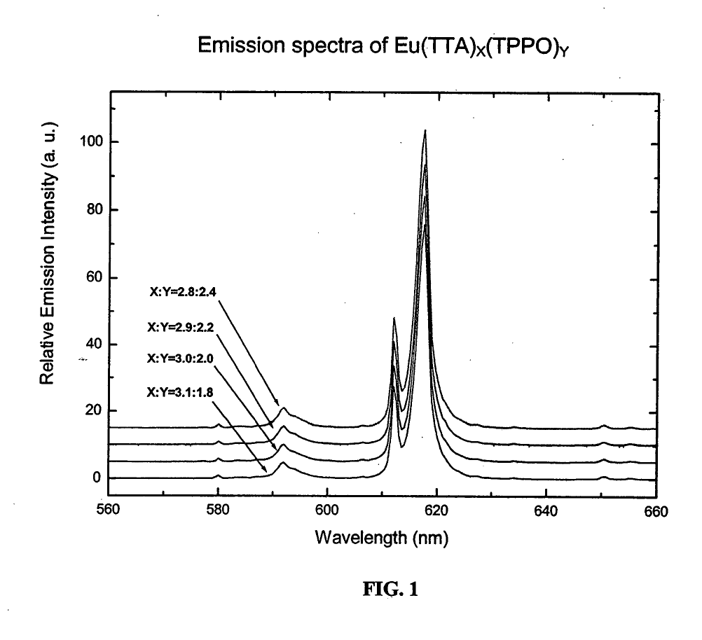

The TTA and TPPO solutions are then mixed at a mole ratio of X:Y=3:2, where x in X=3−x and Y=2+2x takes the value of 0; and stirred thoroughly for 15 to 30 minutes. The Eu³⁺ solution is added drop wise to this ligand mixture during continuous stirring which continues for 2 hours after all of the Eu³⁺ solution has been added. A light yellow colored Eu(TTA)₃(TPPO)₂ phosphor is obtained after washing and drying. As shown in FIG. 1, this sample emits an intense red emission peak at 618 nm and two minor peaks at 582 nm and 610 nm. This pure red line emission of a high intensity which is desired for doping LEDs gives good color sensitivity in display devices.

An alternative ratio in which the TTA and TPPO solutions can be mixed is X:Y=2.8: 2.4, where the value of x in X=3−x and Y=2+2x takes the value of 0.2. When the TTA and TPPO solutions of the same concentration of 1 Mol are mixed in this ratio, the europium phosphor precipitated has a formula Eu(TTA)_{2.8}(TPPO)_{2.4}. An intense red emission peak is also observed at 618 nm with two minor peaks at 582 nm and 610 mm when this sample is exposed to UV or blue light excitation.

Similarly, the mole ratio of the TTA and TPPO solutions can be varied to obtain europium phosphors having different mole ratio combination of the TTA and TPPO ligands such that a general formula: Eu(TTA)ₓ(TPPO)_{Y}, where X:Y=3−x:2+2x and x ranging from −0.5 to 1 is used to represent this particular group of europium phosphors. As can be seen from the various emission spectra in FIG. 1 where the ligand solutions of TTA and TPPO are mixed in a ratio of X:Y=3.1:1.8, 3.0:2.0, 2.9:2.2, 2.8:2.4 to form the respective phosphors: Eu(TTA)_{3.1}(TPPO)_{1.8}, Eu(TTA)_{3.0}(TPPO)_{2.0}, Eu(TTA)_{2.9}(TPPO)_{2.2}, Eu(TTA)_{2.8}(TPPO)_{2.4}, of this particular group of samples, each sample emits an intense red emission peak at 618 nm and two minor peaks at 582 nm and 610 nm when exposed to UV or blue light excitation. It is further observed that the red emissions from these samples increase in intensity as the proportion of TPPO in the phosphor molecule increases from Y=1.8 to Y=2.4 where the sample with the most intense red emission is Eu(TTA)_{2.8}(TPPO)_{2.4}.

This shows that a change in ligand ratio enhances the intensity of the red emission, particularly for samples with higher proportion of TPPO content. This characteristic is observed in phosphors that carry different mole ratio combination of the ligands of TTA and TPPO, in the general formula: Eu(TTA)₃₋ₓ(TPPO)₂₊₂ₓ, where x=−0.5 to 1.

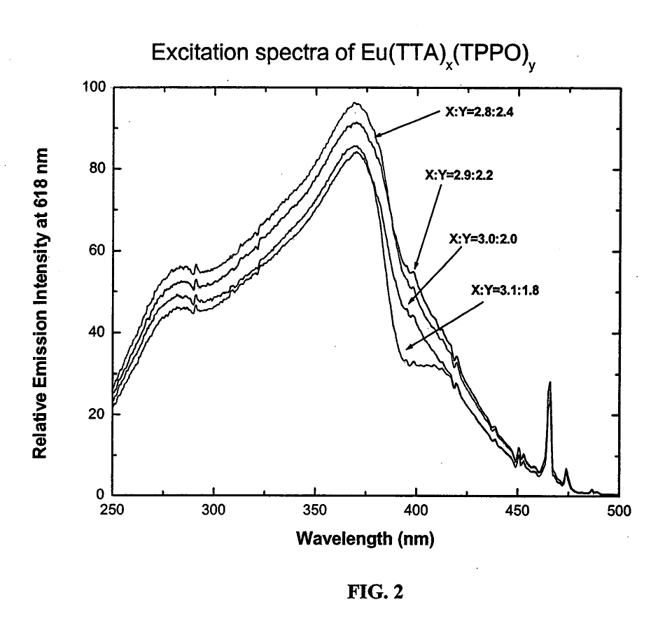

It is further observed from FIG. 2 that a wide excitation band ranging from 250 nm to 470 nm may be applied to obtain the intense red emission peak at 618 nm on any one of the phosphors of the general formula Eu(TTA)₃₋ₓ(TPPO)₂₊₂ₓ, where x=−0.5 to 1. The wide excitation band covers a range that includes short UV, long UV and blue light. It is also observed from FIG. 2 that as Y increases from Y=1.8 to 2.4, the broadness of the excitation band increases. This indicates that the broadness of the excitation band of europium phosphors increases with an increase in TPPO ligand content. This wide excitation band provides an advantage which allows the application of the present phosphors with commercial light emitting diodes (LED) and high efficient LED to provide white light without having to make special adjustments of existing lighting technology or systems.

### Example 2

### Preparation of Eu(NTA)_{3.0}(TPPO)_{2.0}

5 mmol of europium nitrate pentahydrate is dissolved in 20 ml of deionised water to form a solution of europium ion (Eu³⁺) having concentration of about 0.25 Mol. 15 mmol of Naphtyltrifluoroacetone (NTA) is dissolved in 60 ml of Methanol to obtain a β-diketone solution having a concentration of 0.25 Mol. 10 mmol of triphenyl phosphine oxide (TPPO) is dissolved in 40 ml of ethanol to form a solution of phosphine oxide of concentration of 0.25 Mol.

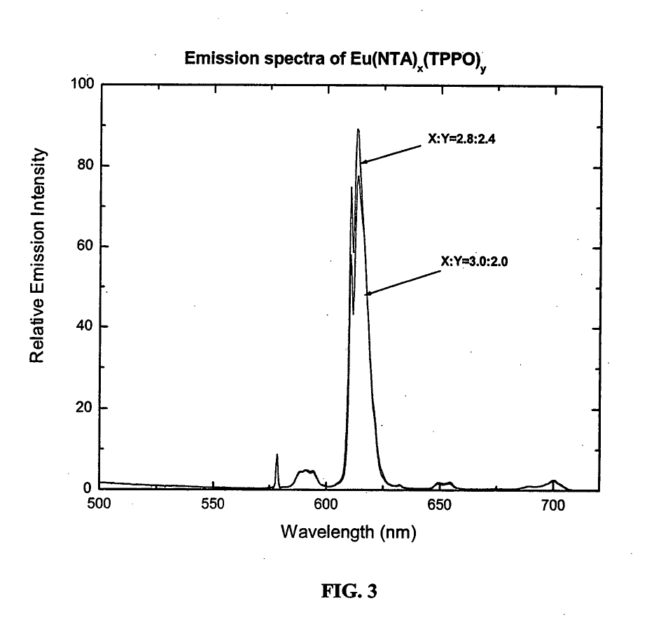

The NTA and TPPO solutions are then mixed at a mole ratio of X:Y=3.0:2.0, where x in X=3−x and Y=2x+2 takes the value of 0; and stirred thoroughly for 15 to 30 minutes. The europium ion (Eu³⁺) solution is added dropwise to this ligand mixture during continuous stirring which continue for 1-2 hours after all of the Eu³⁺ solution has been added. A light yellow colored Eu(NTA)_{3.0}(TPPO)_{2.0} phosphor is obtained after washing and vacuum drying. From FIG. 3, it is shown that this phosphor emits an intense red emission peak at 613 nm and some minor peaks at 610 nm, 578 and 590 nm when exposed to UV light or blue light.

Another sample of this phosphor, prepared by mixing the ligand solutions of NTA and TPPO at a mole ratio of X:Y=2.8:2.4, where x=0.2 to precipitate Eu(NTA)_{2.8}(TPPO)_{2.4}, also emits red intense peak at the same wavelength of 613 nm and some minor peaks at the same respective wavelengths of 610 nm, 578 and 590 nm. The same trend of increased intensity of red line emission from phosphor samples rich in TPPO content is also observed in this example as from the trend in Example 1 above.

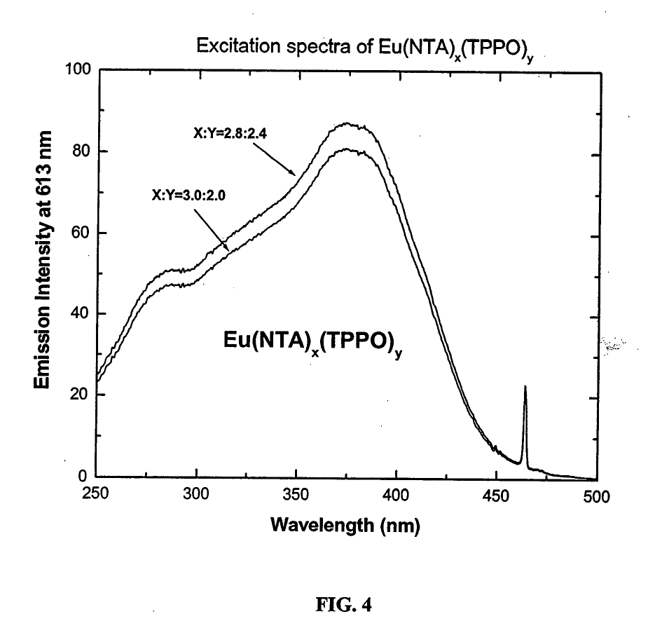

FIG. 4 shows that the excitation spectra of these two samples having the general formula: Eu(NTA)ₓ(TPPO)_{Y} increase in broadness as the TPPO content increases from Y=2.0 to Y=2.4.

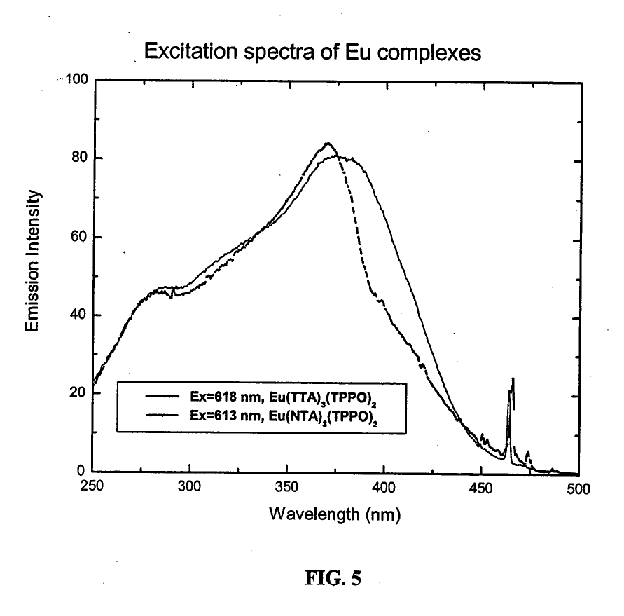

A comparison of the excitation spectra of the europium phosphors having the same ligand ratio of X:Y=3:2, Eu(TTA)₃(TPPO)₂ and Eu(NTA)₃(TPPO)₂, in FIG. 5 shows that the broadness of the excitation band fall within the same range of 250 nm to 470 nm.

From the examples above, the lanthanide phosphors having a general formula Eu(A)₃₋ₓ(B)₂ₓ₊₂ with ligands, A being a β-diketone and B being an organic phosphine oxide, an intense red line emission can be obtained when exposed to a light source that falls within the broad excitation band from 250 nm to 470 nm, making such phosphors highly efficient. Within a family of phosphors (i.e. within the class of phosphors conforming to the general formula: Eu(TTA)ₓ(TPPO)_{Y} or within family of phosphors conforming to the general formula: Eu(NTA)ₓ(TPPO)_{Y}) the intensity of red emission increases with the content of organic phosphine oxide ligand. The broadness of the excitation band also increases with an increase with organic phosphine oxide content of the phosphors within a family that conforms to the same general formula. The ease of preparation of these phosphors also contributes to the viability of these phosphors as compared to prior art process.

It can be seen from the above examples that the present invention provides an advantages in that the synthesis process and the general formula provides for flexibility of adjusting the ratio of the ligand content in the phosphor so as to achieve the desired red line emission from the phosphor upon exposure to, blue, near UV or UV radiation.

The phosphors of the present invention are soluble allowing their application with resins such that LED light can pass through irrespective of the thickness of the resin and still achieve the effect of photoluminescence in the phosphors. This would allow transparent or quasi-transparent epoxy resin mixture to be made for high efficiency in light conversion and provides the application of such phosphor doped LEDs in transparent displays like a product display box or the like.

Various other embodiments of the invention provide advantages complimentary to those already described. It is to be noted that the above description is only illustrative to the present invention and not intended as limiting to the spirit and scope of the invention.

All patents, patent applications, and published references cited herein are hereby incorporated herein by reference in their entirety. While this invention has been particularly shown and described with references to preferred embodiments thereof, it will be understood by those skilled in the art that various changes in form and details may be made therein without departing from the scope of the invention encompassed by the appended claims.

1. A process of synthesizing an organic phosphor comprising:
preparing an ionic solution of a lanthanide series element;
preparing a β-diketone solution;
preparing an organic phosphine oxide solution;
mixing the solutions of β-diketone and organic phosphine oxide at a mole ratio of X:Y to form a homogenous ligand solution, wherein X:Y=3−x:2+2x, −1<x<3; and
adding the ionic solution of the lanthanide series element with continuous stirring to the homogenous ligand solution.

2. The process according to claim 1, wherein −0.5<x<1.

3. The process according to claim 1, wherein the ionic solution of the lanthanide series element is acidic.

4. The process according to claim 1, wherein the lanthanide series element is selected from a group consisting europium, terbium, cerium and erbium.

5. The process according to claim 4, wherein the ionic solution of the lanthanide series element is formed by dissolving a compound of a lanthanide series element in deionized water.

6. The process according to claim 5, wherein the compound of a lanthanide series element is selected from a group consisting of a chloride and a nitrate.

7. The process according to claim 1, wherein the β-diketone solution and the organic phosphine oxide solution have the same concentration.

8. The process according to claim 5, wherein the lanthanide ion solution is a europium ion solution.

9. The process according to claim 8, wherein the mole ratio X:Y is altered to produce phosphors of different stoichiometric combination of β-diketone and organic phosphine oxide ligands.

10. A phosphor produced by a process of synthesizing an organic phosphor comprising:
preparing an ionic solution of a lanthanide series element;
preparing a β-diketone solution;
preparing an organic phosphine oxide solution;
mixing the solutions of β-diketone and organic phosphine oxide at a mole ratio of X:Y to form a homogenous ligand solution, wherein X:Y=3−x:2+2x, −1<x<3; and
adding the ionic solution of the lanthanide series element with continuous stirring to the homogenous ligand solution, the phosphor having a general formula:
Ln(A)₃₋ₓ(B)₂₊₂ₓ
wherein Ln=lanthanide series element;
wherein A=β-diketone;
wherein B=organic phosphine oxide, R₃PO, where R=alkyl, alkylene, aryl, phenyl and their derivatives.

11. The phosphor of claim 10, wherein the lanthanide series element is selected from a group consisting europium, terbium, cerium and erbium.

12. The phosphor of claim 11, wherein Ln=Eu has a general formula
Eu(A)₃₋ₓ(B)₂₊₂ₓ.

13. The phosphor of claim 12 wherein −0.5<x<1.

14. The phosphor of claim 13 produces a red luminescence when exposed to UV light.

15. The phosphor of claim 13 produces a red luminescence when exposed to blue light.

16. The phosphor of claim 13 has a broad excitation spectrum ranging from 250 nm to 472 nm.

17. The phosphor of claim 13 produces a red luminescence at wavelength at 618 nm, 610 nm and 582 nm.

18. The phosphor of claim 13 has an intensity of red luminescence that increases with increase in organic phosphine oxide content.

19. The phosphor of claim 10 is soluble in organic solvents to mix with a resin to form a light converting transparent polymer.

20. A phosphor having a general formula
Ln(A)₃₋ₓ(B)₂₊₂ₓ
wherein A=β-diketone;
wherein B=organic phosphine oxide, R₃PO, where R=alkyl, alkylene, aryl, phenyl and their derivatives;
wherein −0.5<x<0 and 0<x<1.

21. A device comprising
a resin;
a light source; and
a phosphor produced by a process of synthesizing an organic phosphor comprising:
preparing an ionic solution of a lanthanide series element;
preparing a β-diketone solution;
preparing an organic phosphine oxide solution;
mixing the solutions of β-diketone and organic phosphine oxide at a mole ratio of X:Y to form a homogenous ligand solution, wherein X:Y=3−x:2+2x, wherein −1<x<3; and
adding the ionic solution of the lanthanide series element with continuous stirring to the homogenous ligand solution, the phosphor having a general formula:
Ln(A)₃₋ₓ(B)₂₊₂ₓ
wherein Ln=lanthanide series element;
wherein A=β-diketone;
wherein B=organic phosphine oxide, R₃PO, where R=alkyl, alkylene, aryl, phenyl and their derivatives;
wherein the phosphor is dissolved in an organic solvent and mixed with the resin to form a transparent polymer which converts the color of light from the light source that passes through.

22. The device of claim 21, wherein the light source is selected from a group consisting of blue LED, near UV LED and UV LED.

23. The device of claim 21, wherein −0.5<x<1.

24. The device of claim 22, wherein the color of the light source converted by the transparent polymer is dependent on the type of light source and the mole ratio X:Y=3−x:2+2x of A and B in the phosphor, determined by x.

25. The device of claim 21, wherein the lanthanide series element is selected from a group consisting Europium, Terbium, Cerium and Erbium.

26. The device of claim 25, wherein the lanthanide series element is Europium (Eu), Ln=Eu, such that the phosphor in the device has the general formula:
Eu(A)₃₋ₓ(B)₂₊₂ₓ.

27. The device of claim 26, wherein the phosphor produces a red luminescence when exposed to UV light.

28. The device of claim 26, wherein the phosphor produces a red luminescence when exposed to blue light.

29. The device of claim 26, wherein the phosphor has a broad excitation spectrum ranging from 250 nm to 472 nm.

30. The device of claim 26, wherein the phosphor produces a red luminescence at wavelength at 618 nm, 610 nm and 582 nm.

31. The device of claim 21, wherein the phosphor has an intensity of red luminescence that increases with increase in organic phosphine oxide content.

32. A light emitting device comprising
a light source operating in the range of 240 nm to 470 nm; and
a phosphor produced by a process of synthesizing an organic phosphor comprising:
preparing an ionic solution of a lanthanide series element;
preparing a β-diketone solution;
preparing an organic phosphine oxide solution;
mixing the solutions of β-diketone and organic phosphine oxide at a mole ratio of X:Y to form a homogenous ligand solution, wherein X:Y=3−x:2+2x, −1>x>3; and
adding the ionic solution of the lanthanide series element with continuous stirring to the homogenous ligand solution, the phosphor having a general formula:
Ln(A)₃₋ₓ(B)₂₊₂ₓ
wherein Ln=a lanthanide series element;
wherein A=β-diketone;
wherein B=organic phosphine oxide, R₃PO, where R=alkyl, alkylene, aryl, phenyl and their derivatives;
such that on excitation by the light source, the phosphor emits light of high intensity that fall within the range of 580 nm to 620 nm.
